(19) United States
(12) Patent Application Publication
(10) Pub. No.: US 2010/0180560 A1
(43) Pub. Date: Jul. 22, 2010

(54) Device for Exhaust Gas Aftertreatment

(75) Inventors: Michael Micke, Stuttgart (DE); Karin Gerlach, Eningen (DE); Jochen Linhart, Schwaikheim (DE); Kathrin Lichtenwalter, Gerlingen (DE); Sabine Otterbach, Tamm (DE); Holger Findeisen, Marbach (DE)

Correspondence Address: Mann+Hummel GMBH;Department VR-P, Hindenburgstr. 45, Ludwigsburg, 71638, DE

(73) Assignee: MANN+HUMMEL GMBH, Ludwigsburg (DE)

(21) Appl. No.: 12/529,967

(22) PCT Filed: Mar. 7, 2008
(86) PCT No.: PCT/EP08/52789

§ 371 Date: Mar. 20, 2010

(30) Foreign Application Priority Data
Mar. 8, 2007 (DE) 20 2007 003 597.7

(51) Int. Cl. B01D 50/00

(52) U.S. Cl. 55/385.3

(57) ABSTRACT

The invention concerns a device for aftertreatment of a hot exhaust gas flow (2), in particular of a diesel engine, comprising a ceramic filter body (1) of a ceramic material (6) with gas passages (18, 18′). The filter body (1) is formed unitarily of at least one fiber web (4, 4′), in particular paper, impregnated with the ceramic material (6) with formation of the gas passages (18, 18′) and configured with heat exposure by sintering such that fibers of the fiber web (4, 4′) are burnt off and in that the ceramic material (6) is sintered together as a unitary monolithic part to form the filter body (1). At least two ceramic filter bodies (1) are provided that are separately embodied from one another and connected fluidically parallel to one another. Each filter body (1) is limited with regard to its size such that it withstands the thermal loads of the hot exhaust gas flow (2).

### TECHNICAL FIELD

The invention concerns a device for aftertreatment of a hot exhaust gas flow with the features of the preamble of claim 1.

### PRIOR ART

DE 35 01 182 A1 discloses an exhaust gas filter for diesel engines. The ceramic filter bodies disclosed therein have layered areal and porous filter sections between which gas passages are formed. The gas passages are closed off alternatingly. An exhaust gas flow that enters on one side the open gas passages that are open to that side is forced by the closure plugs to flow through the porous filter sections transversely to their surface. The exhaust passages on the opposite side are open in the outflow direction and release the filtered exhaust gas flow.

No information is provided in regard to producing the ceramic filter bodies disclosed therein. Geometrically comparable bodies as they are known, for example, from exhaust gas catalysts, are produced by extrusion. Fine ceramic partitions of the individual gas passages are subject to significant thermal loading so that they have the tendency to form cracks. For avoiding crack formation, segmented extruded filter bodies are known in which several gas passages are combined in a segment. Several such segments adjoin one another with thicker segment walls with increased thickness. The greater thickness of the segment walls in comparison to the passage walls and intermediate gaps are said to ensure a satisfactory thermal stability.

WO 2006/005668 A1 shows a ceramic exhaust gas filter for internal combustion engines whose filter body is comprised of ceramically impregnated paper. A flat and a corrugated impregnated paper web, respectively, are layered for producing a semi-finished product with formation of gas passages and are wound to a coil body. The corrugations of the corrugated paper web have across their entire length a constant shape so that also the gas passages along their longitudinal extension have a constant cross-section. The flow passages are closed off alternatingly by plugs for providing transverse flow through the passage walls. This arrangement enables in comparison to extruded filter bodies more freedom for shaping. A segmentation for avoiding thermal crack formation is however hardly possible for the illustrated coiling technology.

It is an object of the invention to further develop a device of the aforementioned kind such that a higher thermal loading capability is enabled.

This object is solved by the device with the features of claim 1.

### SUMMARY OF THE INVENTION

A device for aftertreatment of a hot exhaust gas flow comprising a ceramic filter body is proposed wherein the filter body is formed integrally from at least one fiber web, especially paper, that is impregnated with ceramic material with formation of gas passages and is sintered. At least two ceramic filter bodies are provided in the device and are configured separate from one another and connected fluidically parallel to one another. Each filter body is limited with regard to its size such that it withstands the thermal loads of the hot exhaust gas flow. The device comprises therefore several individual filter bodies that, considered individually are small and, as a result of their fluidically conducting parallel connection in sum provide a sufficiently large filter element. The small configuration of the individual filter bodies in comparison to the complete filter element prevents thermal and mechanical stress peaks; crack formation is avoided.

The chosen term of filter body comprises in addition to a mechanical filtering action also other forms of purifying exhaust gas aftertreatment, in particular, a catalytic exhaust gas aftertreatment. The individual filter body can thus be embodied as a filter, catalyst, or a combination of both. In an advantageous further embodiment, gas passages of the filter body are arranged in a filter section and provided with areal and porous filter walls wherein the filter walls are designed for passage of the exhaust gas flow transverse to their surface so that neighboring gas passages are alternatingly closed off at an inlet side of the filter section and an outlet side of the filter section by closure plugs, in particular of ceramic material, wherein the filter section relative to a longitudinal direction of the gas passages is positioned between the closure plugs. The closure plugs generate backup of flow that forces the hot exhaust gas flow to pass through the porous filter walls. This causes a mechanical filtration. The thermal and mechanical loads are pronounced and the distribution onto several individual filter bodies is particularly effective for the purpose of avoiding stress peaks.

In an advantageous embodiment, the cross-sections of the gas passages at the inlet side narrow from the inlet side to the outlet side while the cross-sections of the gas passages at the outlet side widen from the inlet side toward the outlet side wherein in particular the passage height remains constant for all gas passages. This cross-sectional course of the gas passages has the result that the flow velocity within the gas passages as well as the pressure differential measured across the filter sections between the gas passages across their length extension are at least approximately constant. The height of the passages that stays the same in this connection enables the formation of coil bodies with overall constant, approximately generally cylindrical cross-section. The filtering load of the filtering sections along the length extension of the gas passages is at least approximately constant.

In an expedient further embodiment the filter bodies are held in a common housing wherein the housing comprises fluidically separated housing sections each provided for an individual filter body. The housing sections that are separate from one another ensure defined flow conditions at the individual filter bodies. The common housing for several filter bodies enables a space-saving and precise mutual positioning of the individual filter bodies with minimal expenditure. The heat dissipation is improved while the mutual fixation of the individual filter bodies in the common housing prevents vibrations and other mechanical loads.

The housing is advantageously formed in the area of the housing sections by half shells that are connected to one another. The half shell configuration enables with simple means the enclosure of several filter bodies and their positional fixation relative to one another.

The ceramic filter bodies are expediently enclosed by a sealing mat, respectively. The sealing mat avoids gas exchange between the individual filter bodies. Additional sealing measures at the side of the housing are not needed. The sealing mat can also act in a mechanically and thermally damping way which reduces the load on the individual filter bodies.

The configuration according to the invention is advantageously used in connection with a ceramic material that in the sintered state has a thermal expansion of greater than approximately 2×10⁻⁶/degree C. and in particular greater than approximately 3×10⁻⁶/degree C. For such a thermal expansion the division into several individual small filter bodies is particularly effective.

### BRIEF DESCRIPTION OF THE DRAWINGS

One embodiment of the invention will be explained in the following in more detail with the aid of the drawing. It is shown in:

FIG. 1 in schematic cross-sectional illustration an extruded segmented ceramic catalyst body according to the prior art.

FIG. 2 in schematic perspective illustration a filter section of a ceramic filter body of ceramically impregnated wound fiber webs.

FIG. 3 a schematic cross-sectional illustration of an inventive exhaust gas aftertreatment device with two separate and fluidically parallel-connected filter bodies according to FIG. 2.

### EMBODIMENT(S) OF THE INVENTION

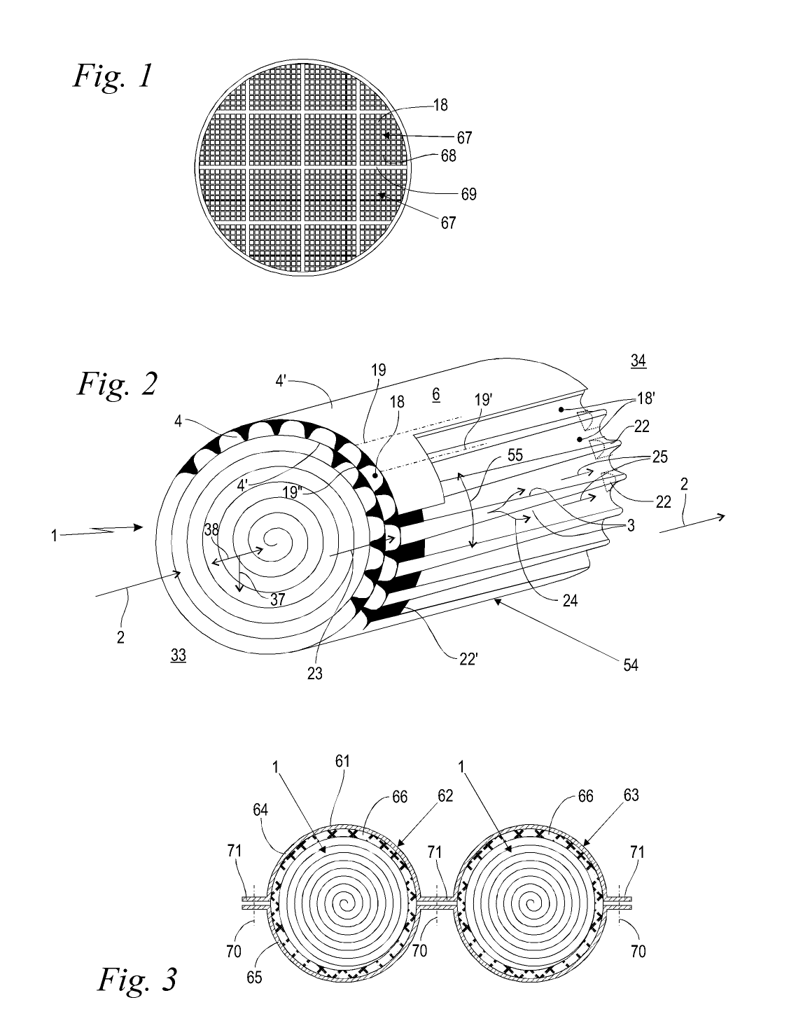

FIG. 1 shows in schematic cross-sectional illustration an extruded segmented ceramic catalyst body according to the prior art. Several continuous gas passages 18 that have a catalytic coat on their inner side are combined to segments 67. Within a segment 67 the gas passages 18 are separated from one another by passage walls 68. Externally, each segment 67 is surrounded by a segment wall 69 with increased thickness. The individual segments 67 are individually extruded, sintered, and joined only section-wise by means of a joining compound, not illustrated. Remote from the joining compound there remains an air gap, not illustrated. The greater thickness of the segment walls 69, the air gaps and the joining compound applied only in partial areas serve for preventing stress cracks.

FIG. 2 shows in a schematic partially sectioned perspective illustration a ceramic filter body 1 with a filter section 54. The selected term of filter body 1 encompasses, in addition to a mechanical filtering action, also other forms of purifying exhaust gas aftertreatment, in particular a catalytic exhaust gas aftertreatment. Instead of the filter section 54 also a catalytic section or in particular a unitary combination of both can be provided. The filter body 1 is part of a device, to be disclosed in more detail in connection with FIG. 3, for a purifying aftertreatment of an exhaust gas flow 2 of a diesel engine of a motor vehicle.

The filter body 1 is made of fiber webs 4, 4′, in particular of filter paper, impregnated with ceramic material 6 and sintered. As ceramic material 6, preferably aluminum oxide, cordierite, mullite, silicon carbide, and/or aluminum titanate are suitable, each individually or in various combinations with one another. For producing the filter body 1 two different fiber webs 4, 4′ are joined to a semi-finished product which is wound to the approximately cylindrically embodied filter body 1. By winding the ceramically impregnated fiber webs 4, 4′ to a wound coil body, a layering direction is produced that is identical to the radial direction 37 of the cylindrical filter body 1. Alternatively, it can also be expedient to arrange several corrugated fiber webs 4 or semi-finished products in a plane and to layer them in a stack arrangement on top one another.

Passage of the filter body by the exhaust gas flow 2 in axial direction 38 of the filter body 1 from an inlet side 33 to an outlet side 34 is provided. For this purpose, the first fiber web 4 is corrugated while a second fiber web 4′ is substantially flat. The chosen term of corrugation comprises corrugations with rounded, for example, sinus-shaped cross-section but also those with angular, for example, triangular, rectangular, or trapezoidal cross-section. As a result of stacking or the coil structure with respect to the radial direction 37 of the filter body 1, a corrugated fiber web 4 and a flat fiber web 4′ are alternatingly stacked on top one another. The corrugated fiber web 4 is connected to the second flat fiber web 4′ along a plurality of at least approximately parallel extending contact lines 19, 19′, 19″. As a result of the corrugated shape of the fiber web 4, the flat shape of the additional fiber web 4′, and the wound structure a plurality of gas passages 18, 18′ are produced that are at least approximately axis-parallel to one another with a height measured in the radial direction 37 that is constant across the axial direction 38. In a circumferential direction 55 of the filter body 1 there are alternatingly a gas passage 18 and a gas passage 18′. The gas passages 18 are open toward the inlet side 33 and in the opposite direction toward the outlet side 38 are closed off by means of closure plugs 22. Relative to the circumferential direction 55, between two gas passages 18 there is one gas passage 18′ that is closed off toward the inlet side 33 by means of a closure plug 22′ and is open toward the outlet side 34. In operation, the exhaust gas flow 2 flows according to arrow 23 axis-parallel into the gas passage 18 that is open toward the inlet side 33. Sidewalls of the ceramic structure formed by the corrugated fiber webs 4, which sidewalls are arranged in the circumferential direction 55, provide a real and porous filter walls 3. The exhaust gas flow 2 that is backed up at the closure plugs 22 is deflected in the circumferential direction 55 in accordance with arrows 24 and flows transversely through the porous ceramic filter sections 3 transversely to their surface. In accordance with the arrows 24, the exhaust gas flow 2 passes through the filter walls 3 into the passages 18 open toward the outlet side 34 and flows out of them in accordance with arrows 25. When passing through the porous filter walls 3, the exhaust gas flow 2 is filtering out entrained soot particles or the like.

The cross-section of the gas passages 18, 18′ changes along the axial direction 38 in that the cross-sections of the inlet-side gas passages 18 narrow from the inlet side 33 to the outlet side 34. In the opposite direction, the cross-sections of the outlet-side gas passages 18′ widen from the inlet side 33 toward the outlet side 34 wherein however for all gas passages 18, 18′ the passage height remains constant. This is achieved by a corrugated shape of the fiber web 4 such that wave peaks are wide at the inlet side 33 and narrow at the outlet side 34. In the illustrated embodiment according to FIG. 2, the width of the wave peaks decreases linearly from the inlet side 33 to the outlet side 34. As a result of the constant passage height and a one-dimensional approximately conical curvature of the fiber web 4 the cross-sectional course is also approximately linear. However, a deviating non-linear course in particular by multi-dimensional spatial curvature of the fiber web 4 can be expedient. Alternatively, a wave configuration can be advantageous in which the gas passages 18, 18′ have a constant cross-section from the inlet side 33 to the outlet side 34.

The exhaust gas flow 2 entering in the direction of arrows 23 into the gas passages 18 passes across the entire length extension of gas passages 18, 18′ through the filter sections 3 in accordance with arrows 24. In this way, the volume flow 23 at the inlet side is reduced in the gas passage 18 across its length extension while the volume flow 25 at the outlet side in the gas passage 18′ increases across the length extension. The afore-mentioned cross-sectional course of the gas passages 18, 18′ has the results that the flow velocity within the gas passages 18, 18′ as well as pressure differential measured across the filter sections 3 between the gas passages 18, 18′ along their length extension is at least approximately constant. The filtering load of the filter sections 3 is thus at least approximately constant across the length extension of the gas passages 18, 18′.

As an example, for manufacture first a shaping of the fiber webs 4, 4′ and a ceramic impregnation in particular with a ceramic emulsion is carried out. The fiber webs 4, 4′ are then joined to the aforementioned semi-finished product. In this connection at least one bead of ceramic material is placed between the fiber webs 4, 4′ that form the future closure plugs 22′. It can be seen that the corrugated fiber web 4 with its wave peaks rests against the fiber web 4′ positioned above it along the contact lines 19, 19′ indicated in dashed lines and is joined therewith along the contact lines 19, 19′. In the manufacture of the semi-finished product, the attachment can be achieved by a suitable glue. In the illustrated embodiment, the attachment is realized through ceramic material 6. In the joined state of the semi-finished product the future gas passages 18, 18′ are preshaped by the corrugated structure of the fiber web 4 and the smooth shape of the fiber web 4′ wherein sidewalls of the corrugated fiber webs 4 in the filter section 54 are provided for the formation of the future filter walls 3.

The semi-finished product that has been impregnated by or immersed in the ceramic emulsion containing the ceramic material 6 is wound or stacked in the wet state, i.e., with not yet completely dried ceramic emulsion, into the shape of the future filter body 1 according to FIG. 2. In this connection, at least one bead of ceramic material is placed between the fiber webs 4′, 4 and forms the future closure plugs 22. Upon winding or stacking, the wave troughs of the corrugated fiber web 4 across the contact lines 19″ are connected to the flat fiber webs 4′ positioned underneath so that in addition to the gas passages 18 also the further gas passages 18′ in the radial direction 37 and in the circumferential direction 55 of the approximately cylindrical filter body 1 (FIG. 1) are closed. The attachment at the contact lines 19″ is carried out in the same way as at the contact lines 19, 19′. Alternatively, it can be expedient to produce the blank first of ceramically not yet impregnated fiber webs 4, 4′ and to impregnate subsequently the blank, for example, in an immersion bath with a ceramic material.

The filter blank that is produced in this way is first dried and subsequently is sintered in a sintering furnace under the action of heat wherein the ceramic material 6 including the closure plugs 22, 22′ is sintered to a monolithic ceramic body. At the high sintering temperature the material of the fiber webs 4, 4′ is burnt off so that a certain porosity of the ceramic material 6 is achieved. The porosity is designed such that the exhaust gas flow 2 passes through the ceramic filter walls 3 transverse to their face.

The ceramic material 6 forming the filter body 1 has in the sintered state a thermal expansion of greater than approximately 2×10⁻⁶/degree C., in the illustrated embodiment of greater than approximately 3×10⁻⁶/degree C.

FIG. 3 shows in a schematic cross-sectional illustration a device according to the invention for aftertreatment of the hot exhaust gas flow 2 illustrated in FIG. 2 which device is designed for an exhaust gas device of a diesel engine of a motor vehicle. The illustrated device comprises, for example, two ceramic filter bodies 1 according to FIG. 2 that are embodied separately from one another and are connected fluidically parallel to one another. It may also be expedient that three or more individual ceramic filter bodies 1 are provided. Each individual filter body 1 is limited with regard to its size such that it withstands the thermal and also mechanical loads of the hot exhaust gas flow 2 according to FIG. 2. The maximum size of each individual filter body 1 is derived from the thermal and mechanical load to be expected in operation in connection with the aforementioned material-caused thermal material expansion. Based on the size of the individual filter bodies 1 determined in accordance with these parameters and the entire volume flow of the hot exhaust gas flow 2 according to FIG. 2, the required number of filter bodies 1 to be combined to the device according to the invention in the way described in the following can be derived. Each individual filter body 1 is flown through in parallel in accordance with the illustration according to FIG. 2 by a partial flow of the hot exhaust gas flow 2. The sum of all filter bodies 1 generates the predetermined purifying aftertreatment of the hot exhaust gas flow 2 (FIG. 2). In accordance with the appropriate configuration of the individual filter bodies 1, the device according to the invention can also be provided for catalytic aftertreatment of the exhaust gas flow of a gasoline engine of a motor vehicle or the like. The use in stationary engines, in heating devices or the like is also conceivable.

The filter bodies 1 are contained in a common housing 61 wherein the housing 61 comprises fluidically separate housing sections 62, 63 each provided for an individual filter body 1. For this purpose, the housing 61 according to the illustrated embodiment is configured in the area of the housing sections 62, 63 of two connected half shell 64, 65. For connecting the half shells 64, 65 with one another, they have flanges 71 outside of the individual housing sections 62, 63 as well as between them where they are screw-connected to one another as indicated in an exemplary fashion by the corresponding dashed lines 70. It may also be expedient to employ welding, soldering, crimping or another form of connection. In addition to the half shells 64, 65 there are also non-illustrated inlet and outlet pipes that are separately embodied but can also be formed as a monolithic part of the half shells 64, 65. The aforementioned fluidic separation of the individual housing sections 62, 63 and thus of the individual filter bodies 1 is generated on the one hand by the intermediately positioned flanges 70 that in the connected state avoid a transverse flow. On the other hand, each ceramic filter body 1 is circumferentially surrounded by a sealing mat 66 so that a fluidic sealing action of the filter body 1 to the neighboring flanges 71 is provided. The sealing mat 66 contacts areally the outer side of the respective filter body 1 and also areally the correlated inner side of the housing 61. In this way, the filter body 1 is held without play in the housing 61 but is secured so as to be thermally and mechanically dampened.

As an alternative to the illustrated half shell configuration of the housing 61 it can also be expedient to configure the housing 61 of pipes into which a filter body 1 is inserted, respectively, optionally by shrink-fitting. A further advantageous embodiment can be that for forming the housing 61 a sheet metal is bent to a tubular shape and subsequently joined and in particular welded. It can also be advantageous to wind or bend a sheet metal about the respective filter body 1 and to subsequently weld it or connect it in another way.

1. Device for aftertreatment of a hot exhaust gas flow (2), in particular of a diesel engine, comprising
a ceramic filter body (1) of a ceramic material (6) with gas passages (18, 18′),
wherein the filter body (1) is formed unitarily of at least one fiber web (4, 4′), in particular paper, impregnated with the ceramic material (6), with formation of the gas passages (18, 18′) and configured with heat exposure by sintering such that fibers of the fiber web (4, 4′) are burnt off and
in that the ceramic material (6) is sintered together as a unitary monolithic part to form the filter body (1),
characterized in that at least two ceramic filter bodies (1) are provided, are separately embodied from one another, and are connected fluidically parallel to one another,
wherein each filter body (1) is limited with regard to its size such that it withstands the thermal loads of the hot exhaust gas flow (2).

2. Device according to claim 1, characterized in that
the gas passages (18, 18′) are arranged in a filter section (54) of the filter body (1) and provided with areal and porous filter walls (3),
wherein the filter walls (3) are provided for passage of the exhaust gas flow (2) transversely to their surface,
wherein neighboring gas passages (18, 18′) are alternatingly closed off at an inlet side (33) of the filter section (54) and at an outlet side (34) of the filter section (54) by closure plugs (22, 22′), in particular of ceramic material, and
wherein the filter section (54) relative to a longitudinal direction (38) of the gas passages (18, 18′) is positioned between the closure plugs (22, 22′).

3. Device according to claim 2, characterized in that
the cross-sections of the gas passages (18) at the inlet side narrow from the inlet side (33) toward the outlet side (34) and
in that the cross-sections of the gas passages (18′) at the outlet side widen from the inlet side (33) toward the outlet side (34),
wherein in particular for all gas passages (18, 18′) the passage height remains constant.

4. Device according to claim 1, characterized in that
the filter bodies (1) are secured in a common housing (61)
wherein the housing (61) comprises fluidically separate housing sections (62, 63) each provided for an individual filter body (1).

5. Device according to claim 4, characterized in that
the housing (61) in the area of the housing sections (62, 63) is formed by half shells (64, 65) connected to one another.

6. Device according to claim 1, characterized in that
the ceramic filter body (1) is enclosed by a sealing mat (66).

7. Device according to claim 1, characterized in that
the ceramic material (6) in the sintered state has a thermal expansion of greater than approximately 2×10⁻⁶/degree C.

8. Device according to claim 7, wherein
the ceramic material (6) in the sintered state has a thermal expansion of greater than approximately 3×10⁻⁶/degree C.

9. Device according to claim 5, wherein
the ceramic filter body (1) is enclosed by a sealing mat (66).

10. Device according to claim 3 wherein,
the filter bodies (1) are secured in a common housing (61);
wherein the housing (61) comprises fluidically separate housing sections (62, 63) each provided for an individual filter body (1); and
wherein the housing (61) in the area of the housing sections (62, 63) is formed by half shells (64, 65) connected to one another.
